(19) United States
(12) Patent Application Publication
(10) Pub. No.: US 2017/0110096 A1
(43) Pub. Date: Apr. 20, 2017

(54) HEADLIGHT SYSTEM WITH PROJECTOR

(71) Applicant: Jabil Optics Germany GmbH, Jena (DE)

(72) Inventor: Norman Kuehn, Jena (DE)

(73) Assignee: Jabil Optics Germany GmbH, Jena (DE)

(21) Appl. No.: 15/293,457

(22) Filed: Oct. 14, 2016

(30) Foreign Application Priority Data
Oct. 15, 2015 (DE) 102015117546.0

(51) Int. Cl. G09G 5/38; B60Q 1/08; G09G 5/10; B60Q 1/00; G03B 29/00; H04N 9/31

(52) U.S. Cl. CPC G09G 5/38; G03B 29/00; H04N 9/3185; H04N 9/3194; H04N 9/3147; G09G 5/10; B60Q 1/0023; B60Q 1/085; G09G 2380/10; G09G 2340/0464

(57) ABSTRACT

The invention relates to a headlight system with a projector (1) comprising at least one image generator and a method (20) for projecting image contents. In order to adjust positions of image contents of the projected partial images to positions or movements of objects and/or living things, it is envisaged according to the invention that the position of the image contents be displaced on at least one of the image generators.

### FIELD OF INVENTION

The invention relates to a headlight system for a vehicle, having a projector for selectively illuminating a projection area in different ways, wherein the projector comprises at least one projection device having an image generator, wherein the image generator presents image contents for selective illumination in different ways during operation, and the projector is configured to project the image contents into the projection area. The invention further relates to a method for illuminating a section of the road having a vehicle, in which an object and/or a living thing on or adjacent to the section of the road is illuminated differently by the vehicle to the surroundings thereof. In addition, the invention relates to a vehicle having a headlight system.

### BACKGROUND

There are known headlight systems for vehicles, vehicles with headlight systems and methods for illuminating sections of road having a vehicle, wherein objects or living things are illuminated differently to the surroundings thereof. Movable headlights, mirrors or lenses must be used to compensate for relative movements. However, achieving this mechanical movement is complex.

### SUMMARY

### Technical Problem

The problem underlying the invention may therefore be to illuminate objects and living things differently to the surroundings thereof by means of a less complex process.

### Technical Solution

The problem may be solved for the headlight system referred to above in that the projector is configured to displace the image contents on the image generator, in order to compensate for a relative movement between at least one selectively differently illuminated object and/or a selectively differently illuminated living thing in the projection area and the headlight system. The problem is solved for the vehicle referred to above in that the headlight system of the vehicle is the headlight system according to the invention. In the case of the above-mentioned method the problem may be solved in that a relative movement of the vehicle is compensated for with respect to the object and/or the living thing by displacing image contents producing the different illumination on an image generator of a headlight system of the vehicle, in order to continue to illuminate the object and/or the living thing differently.

Since the image contents on the image generator are displaced, the position of the projection device or of the image generator of the projection device does not need to be amended or changed. It may therefore not be necessary to mechanically adjust the position of the projection device itself or of other elements of the projection device, which may possibly be a complex process.

The solution according to the invention can be further improved by means of various embodiments which may each be advantageous and which, unless otherwise stated, can be combined with one another as desired. These embodiments and the advantages associated therewith will be explained in detail below.

The projector can therefore be configured to selectively illuminate the object and/or the living thing differently to other sections of the projection area and, in particular, to the surroundings thereof. It can thus probably be ensured that objects and/or living things can be better identified or are dazzled less, or that light reflected by these causes less dazzling. For example, if the object is a highly reflective sign, the light reflected by this sign can dazzle occupants of the vehicle comprising the projector, if the sign is illuminated too much.

The projector can be configured to also selectively illuminate the object and/or the living thing differently to other sections of the projection area, if the headlight system is moved relative to the object and/or the living thing. As a result, the advantages of the different illumination may be retained, even if the vehicle is moving relative to the object and/or the living thing. For example, the vehicle can be moving. Alternatively or additionally, the living thing, for instance a wild animal, a pedestrian or a cyclist, or another vehicle can be moving. As long as the object and/or the living thing is in the projection area, it can be illuminated differently to the surroundings thereof irrespective of the relative movement thereof, so that said object or living thing may be visible for longer and/or better visible, or causes less dazzling or is dazzled less.

The headlight system can comprise a camera which is configured to record the projection area. The respective position of the objects and/or living things in the projection area and of image contents projected into the projection area can be easily identified with the camera. In addition, the camera can record the brightness of the light reflected by the objects and/or living things and convert these, like the positions, into an image signal. However, the headlight system can also be operated with a camera which is not part of the headlight system, but for example part of the motor vehicle.

The headlight system can comprise a control device which is connected to the camera for receiving the image signal and is connected to the at least one image generator for transmitting the control signal. The image signal can be evaluated and a control signal produced for the image generator in the control device. The control signal can be used to displace image contents on the image generator and/or to change the brightness of the image contents. However, the control device can also be part of the motor vehicle and can, for example, be a control unit of the motor vehicle.

The headlight system can comprise two projection devices which each have an image generator, wherein each of the image generators produces image contents to be selectively illuminated in different ways during operation, and the projector is configured to project the image contents of one of the image generators into a first section of the projection area, and the image contents of the other image generator into a second section of the projection area, wherein the sections of the projection area are arranged with respect to one another without any gaps or overlapping one another. As a result, the projection area can be enlarged compared to a headlight system having only one projection device, so that the advantages of the different illumination can be available for longer, even if the object and/or the living thing is/are moving relative to the vehicle. Alternatively, the sections of the projection area can also be arranged with a gap between one another, in order to be able to arrange the projection area according to different requirements.

The control device can be configured to determine an actual position of the image contents in the projection area on the basis of an image signal of the camera and to displace the position of the image contents on the image generator in such a way that the image contents in the projection area can be projected to a nominal position.

The projector can further be configured to project the image contents of the at least one projection device, wherein the control device is configured to determine the nominal position of the projected image contents depending on an actual position and/or a change of position of an object and/or living thing which can be acquired during operation with the camera.

The at least one projection device can be a headlight of the headlight system, so that the projection device can be present instead of a headlight of the vehicle and does not have to be additionally provided.

The vehicle according to the invention can be a motor vehicle and, for example, a road or rail-mounted vehicle, for example a car or a motorcycle or a train. Alternatively, the vehicle can be an aircraft, for instance an airplane or a helicopter, wherein the projection area can be a take-off and/or landing area of the aircraft or an area which has to be monitored. Finally, the vehicle can be a watercraft, for instance a boat or a ship, and the projection area can be a section on or in front of the watercraft or of a mooring.

The projector can be configured to compensate for a relative movement of the vehicle with respect to an object or a living thing in the projection area, in order to possibly be able to better identify said object or living thing.

The projector can be configured to illuminate the projection area such that the projection area overlaps a planned route of the vehicle at least in part and, for example, a section of the road.

The projection area can extend right into an area adjacent to the route and, for example, adjacent to the section of the road and/or above the route and, for example, the section of the road, in order to possibly also be able to easily identify objects and living things adjacent to the route, for example other vehicles, signs, people or animals.

In particular, if the projector comprises at least or precisely two projection devices, the projection area can not only be particularly large. In addition, the projector can optionally or additionally be configured to project an overall image comprising image contents of the two projection devices, wherein the control device is configured to determine the nominal position of image contents or partial images projected with one of the projection devices depending on the actual position of image contents or partial images projected with the other of the projection devices.

Not only can the image contents of the overall image be used to be able to better identify objects or living things but, in addition, information for the occupants can be projected as image contents. Consequently, the partial images can be simply displaced relative to one another until both partial images are arranged at their nominal position and produce the overall image. The nominal position of one of the partial images can thereby be adjusted by means of the actual position of the other of the partial images so that only the position of the image contents of one of the partial images or of the partial image itself is to be amended on the image generator. According to the method according to the invention, the nominal position of one of the partial images can therefore be determined on the basis of the actual position of the respective other of the partial images. Alternatively or additionally, the nominal position of at least one of the partial images can be determined on the basis of the object.

Alternatively or additionally, the projector can be configured to project an overall image comprising image contents of the two projection devices, wherein the control device is configured to determine nominal positions of image contents projected with at least one of the or with both projection devices depending on a position of an object or living thing which can be acquired during operation with the camera. The object or the living thing can, in this case, be arranged inside or outside the projection area. The image contents of a partial image projected with one of the projection devices can therefore be aligned not only relative to the other partial image or to the image contents thereof, but alternatively or additionally aligned with respect to the object or living thing as well.

The partial images or the image contents thereof can overlap one another or can be adjacent to one another, in order to produce the overall image.

Therefore, objects or living things selected as image contents and present in the projection area can therefore be illuminated less brightly or even omitted or illuminated more intensely than other sections of the projection area and, for example, than other objects or living things in the projection area. The object or the living thing can therefore be deliberately illuminated less brightly or more brightly, wherein the image contents constitute precisely a less bright, i.e. darker, or lighter area in the surrounding overall image. As a result, the object or the living thing in the overall image can be illuminated more brightly, for example, in order to make it more visible. Less brightly illuminated sections prevent unnecessary dazzling, for example, of oncoming traffic or of the driver of a motor vehicle, for instance if a large and highly reflective road sign is lit up.

If two projection devices are provided, each of the projection devices can in each case be a headlight of the headlight system.

The image contents can constitute at least in part information for the operator of the motor vehicle, wherein the information is projected with image contents of the at least one image generator or is projected with one of the partial images or divided up among the partial images. For example, the current speed limit and/or at least one symbol can be projected onto the projection area. If the projector is part of the headlight system of a car, the projection area can be the road in front of the motor vehicle. According to the method according to the invention, related information can therefore be projected to the vehicle operator or the driver of the motor vehicle, divided up among the partial images.

If objects or living things, for instance animals or people, are on or adjacent to the route or the road, the projection area can also extend up to adjacent to the route or the road. Living things on or adjacent to the route or the road can then be illuminated more brightly than the surroundings thereof, so that the vehicle operator identifies the living things more quickly. An oncoming vehicle can be lit up more darkly or even not lit up at all, in order to prevent the vehicle operator being dazzled. An object, for instance a road sign, can also be illuminated more brightly than the surroundings thereof, in order to better identify it. If the object and, for example, the road sign reflects light intensely, the object can be illuminated less intensely so as not to adversely affect the driver of the vehicle by the bright reflection and to nevertheless allow the contents of the sign to be identified. The surroundings of the object can be illuminated differently and in particular more brightly or more darkly than the object, so as not to dazzle third parties or to better illuminate the surroundings of the object to make it easier to identify. Both the more brightly illuminated and the less illuminated and, possibly, even the omitted area can be easily adjusted to the relative movement between the motor vehicle and the objects and/or living things or the oncoming vehicle, by moving the image contents or partial images on the image generator, without having to mechanically align the headlights by means of an elaborate process.

Alternatively or additionally, the image contents can differ in terms of color from other sections of the illuminated projection area. If the motor vehicle is moving, for example, faster than permitted, the maximum permissible speed limit, for instance 100 km/h, or the current too high speed can be projected in red.

Alternatively or additionally, other information, for example navigation elements such as arrows or distance markers from the vehicle driving in front, can be projected onto the road. Projected symbols do not necessarily need to be navigation elements or distance markings. Other symbols are also possible. For example, a picture mark, a logo, lettering or any predetermined image can be projected as image contents.

If the image generator is pixel-based, so that it comprises multiple pixels which are arranged in a matrix, for example, the image contents of the partial image or the partial image itself can be displaced pixel by pixel, for instance in an image memory associated with the image generator, in order to move the image contents projected into the projection area or the partial image projected into the projection area toward the nominal position.

An image generator is preferably an electronic device for converting an electric image signal into an optical image signal or image. Such an imaging electronic device is, for example, a liquid crystal display (LCD), a micromirror array (DLP, DMD), a light-emitting diode arrangement (multiple LEDs) or a laser. The liquid crystal display can be provided with a light source of the respective projection device in a transmitted-light arrangement or in a reflection arrangement. The micromirror array can be configured with the light source in a reflection arrangement. Light-emitting diode arrangements or laser arrangements do not require separate illumination.

If the image contents or the entire partial image on the image generator is/are displaced, it is possible for a section of one of the image contents or of the partial image to be displaced so far that the section is arranged outside the image generator. The control device can therefore be configured to displace image contents or partial images beyond an edge of a section of the image generator which produces the optical image signal.

For example, the image section can be located outside the area projected by the projector. One of two headlights can then, for example, be in an off position or even be switched off, and the entire image contents can be projected by the second headlight.

The image generator can, for example, be a DMD which is firmly positioned in the projector, an LCD (Liquid Crystal Display) or an LCOS (Liquid Crystal on Silicon) which is illuminated. Alternatively, the image generator can be a firmly positioned laser device. The image generator as such is not displaced in the projector, in order to be able to continue to illuminate the object and/or the living thing differently even in the event of a relative movement.

The position of the partial image can be determined on the basis of the position of an edge of the partial image or on the basis of the position of image contents of the partial image. The position of the image contents can be determined, for example, by means of pattern or edge detection. Positions of objects and/or living things which can be detected with the camera can, for example, also be determined by pattern or edge detection.

### BRIEF DESCRIPTION OF THE DRAWINGS

The invention will be explained by way of example below using embodiments and with reference to the drawings. The different features of the embodiments can thereby be combined independently of one another, as has already been explained in the case of the individual advantageous embodiments.

FIGS. 1 and 2 show a schematic diagram of an embodiment example of the projector according to the invention,

FIGS. 3 and 4 show a schematic diagram of another embodiment example of the projector according to the invention,

FIG. 5 shows a schematic diagram of an embodiment example of the method according to the invention, and

FIG. 6 shows a schematic diagram of an embodiment example of the vehicle according to the invention.

### DETAILED DESCRIPTION OF THE PREFERRED EMBODIMENTS

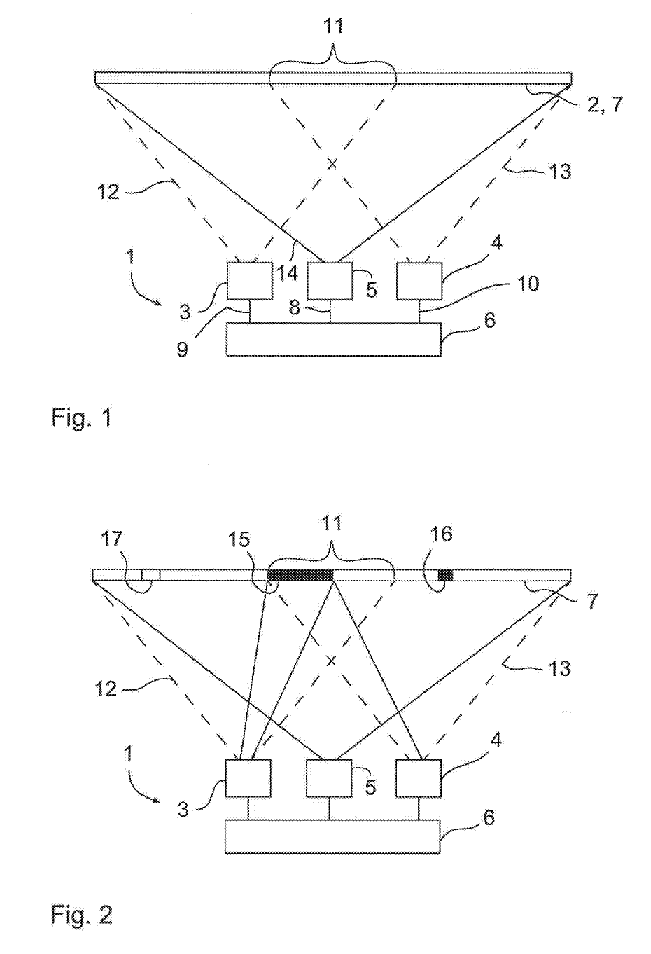

The construction and function of a projector according to the invention will first be described with reference to the embodiment example shown in FIG. 1.

FIG. 1 shows the projector 1 having a projection surface 2 which is provided, for example, by a road. The projector 1 comprises by way of example two projection devices 3, 4, a camera 5 and a control device 6.

The two projection devices 3, 4 are directed at a projection area 7 arranged on the projection surface 2, onto which they each project an image. If the projected images produce an overall image, the images can be referred to as partial images of the overall image. The partial images each comprise image contents which, together, can form the image contents of the overall image. The camera 5 is also configured and aligned to image the projection area 7 at least in part or even completely. For example, the camera 5 is directed at the projection area 7. During operation, the camera 5 produces an image signal which is representative of image contents of at least one section or of the entire projection area 7. The camera 5 is connected to the control device 6 for transmitting the image signal. For example, an image signal line 8 connects the camera 5 with the control device 6 for transmitting the image signal.

The control device 6 is connected with at least one and, for example, with both of the projection devices 3, 4 for transmitting the control signal. For example, the control device 6 is connected by means of a control signal line 9, 10 respectively with one each of the projection devices 3, 4, for transmitting a control signal 3, 4.

The control device 6 is configured, on the basis of the image signal, to determine an actual position of at least one of the partial images or of image contents of at least one of the partial images in the projection area 7. If the actual position of the partial image or of the image contents deviates from the nominal position, the control device 6 emits a control signal to the projection device 3, 4. On the basis of the control signal the position of the image contents, or of the partial image, is displaced towards the nominal position, wherein the position of the image contents or of the relevant partial image is displaced on an image generator of the respective projection device 3, 4 until the image contents or the partial images in the projection area can be projected to the respective nominal position.

The projection devices 3, 4 can each comprise an image generator. An image generator is preferably an electronic device for converting an electric image signal into an optical image signal or image. Such an imaging electronic device is, for example, a liquid crystal display (LCD), a micromirror array (DLP, DMD), a light-emitting diode arrangement (multiple LEDs) or at least one laser. The liquid crystal display can be provided with a light source of the respective projection device 3, 4 in a transmitted-light arrangement or in a reflection arrangement. The micromirror array can be configured with the light source in a reflection arrangement. Light-emitting diode arrangements or laser arrangements do not require separate illumination.

If the image generator is pixel-based, so that it comprises multiple pixels which are arranged in a matrix, for example, the image contents of the partial image or the partial image itself can be displaced pixel by pixel, for instance in an image memory associated with the image generator, in order to move the image contents projected into the projection area 7 or the partial image projected into the projection area 7 toward the nominal position.

In the embodiment example shown in FIG. 1, the camera 5 is arranged between the projection devices 3, 4. In particular, the projection devices 3, 4 are arranged on opposite sides of the camera 5 and at identical distances from the camera 5 in accordance with FIG. 1. If the projection devices 3, 4 are, for example, part of a headlight system of a car, the camera 5 can be arranged in the radiator or in the housing of the rear-view mirror of the car. The camera 5 can, however, also be arranged differently, provided that the projection area 7 can be imaged at least in part or even completely with the camera 5. In particular, it can suffice if an overlap area 11, in which the images projected with the projection devices 3, 4 overlap, can be imaged with the camera 5. It is then of course possible that image contents projected with one of the projection devices 3, 4 or the partial image projected with this projection device 3 are aligned with respect to image contents projected with the other projection device 4 or with respect to the partial image projected with the other projection device 4. The nominal position of the image contents of one of the projected images can therefore be specified by the actual position of image contents of the other of the projected partial images in the projection area 7. However, the camera preferably images the projection area completely.

Alternatively or additionally, the control device 6 can be configured to determine a nominal position of image contents of a projected partial image based on a position of a living thing and/or object which can be acquired with the camera 5 during operation. The living thing and/or object can be arranged outside the projection area 7. The object can, for example, be a lane marker. It is therefore possible to specify image contents of at least one of the projected partial images on the basis of the living organism and/or object and image contents of the other of the projected partial images on the basis of the position of the other partial image or of the image contents projected with this partial image.

If both the object and image contents of both projected partial images can be imaged with the camera 5, the image contents of both partial images, or both partial images themselves, can be aligned on the basis of the object.

The partial images, or the image contents thereof, can alternatively also be projected free of any overlapping, therefore adjacent to one another or at a distance from one another. On the basis of the image signal produced with the camera 5, the partial images or the image contents thereof can nevertheless be aligned, if the image contents of both partial images and, optionally, the object as well are detected.

Projection cones 12, 13 of the projection devices 3, 4 are shown in FIG. 1 with the dashed lines which each extend from the projection devices 3, 4 towards the projection area 7. Solid lines extending from the camera 5 toward the projection area 7 limit the beam path to the inlet port of the camera 5, wherein the inlet port is arranged in the projection area 7 of the projector 1. The solid lines therefore indicate an inlet port cone 14 of the camera 5.

The inlet port cone 14 of the camera 5 can include at least the overlap area 11 and be limited to this. Alternatively, the inlet port cone 14 of the camera 5 can be limited to sections of the projection area 7 outside the overlap area 11. In addition to the overlap area 11, the inlet port cone 14 can further include additional areas of the projection area 7. Alternatively or additionally, the inlet port cone 14 can include living things and/or objects arranged outside and/or inside the projection area 7.

FIG. 2 shows the embodiment example of FIG. 1, wherein at least one section of the projection area is illuminated more darkly than other sections of the projection area 7.

The projected image contents therefore constitute different levels of illumination. Sections of the projection area 7 can therefore be illuminated more brightly or more darkly as image contents. In the embodiment example shown in FIG. 2, a section 15 arranged in the overlap area 11 is illuminated more darkly than areas of the projection area 7 surrounding the section 15. Another section 16 of the projection area 7 is also illuminated less intensely, therefore more darkly, than areas of the projection area 7 surrounding it. Another section 17 which is also arranged by way of example outside the overlap area 11 is illuminated more brightly than other sections of the projection area 7 surrounding it.

For example, the projection area 7 can be a part of a route, wherein the route is to be illuminated with differing levels of brightness. The location of the differently illuminated sections 15, 16, 17 can itself be governed, for example, by objects or living things present on or by the route, so that the darker or brighter sections 15, 16, 17 move with the objects or living things and, to this end, the image contents generating the differently illuminated sections are displaced on the image generators.

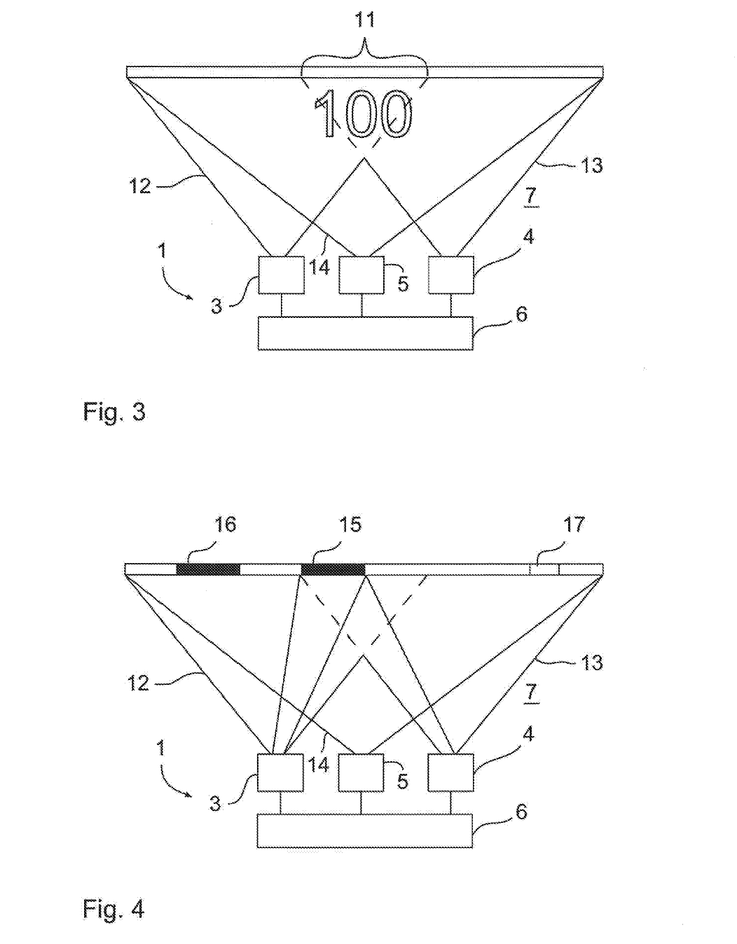

FIGS. 3 and 4 show the embodiment example of the previous figures.

The projector 1 of the embodiment example shown in FIGS. 3 and 4, such as the embodiment example shown in FIGS. 1 and 2, is part of a headlight system of a vehicle. For example, the projection devices 3, 4 are each a headlight of the headlight system, wherein the headlights can be provided to illuminate the route the vehicle is driving along.

The projection area 7 is shown in FIGS. 3 and 4, by way of example, as a horizontal projection area 7, for example a road on which the vehicle is stationary or traveling. In FIG. 3, by way of example, the maximum permissible speed of 100 kilometers per hour (km/h) is projected as image contents, wherein the image contents are arranged in the overlap area 11 and also outside the overlap area 11. Alternatively or additionally, at least one symbol can be projected as the image contents as well. The image contents are, for example, more brightly illuminated than other sections of the illuminated projection area 7. Alternatively or additionally, the image contents can differ in terms of color from other sections of the illuminated projection area 7. If the vehicle is moving, for example, faster than permitted, the maximum permissible speed limit of 100 km/h can be projected in red. Alternatively or additionally, other information, for example navigation elements such as arrows or distance markers from the vehicle driving in front, can be projected onto the road.

Projected symbols do not necessarily need to be navigation elements or distance markings. Other symbols are also possible. For example, a picture mark, lettering or any predetermined image can be projected as image contents.

Alternatively or additionally, as shown in FIG. 4, and as already described with reference to FIG. 2, sections of the projection area 7 can be illuminated with different levels of brightness and, for example darker or lighter than other sections of the projection area 7. The image contents here also comprise the lighter and/or darker sections.

In the embodiment example shown in FIG. 4, the darker section 15 is aligned, for example, so that a driver of a vehicle driving in front is not dazzled via his rearview mirror by the light of the headlights of the motor vehicle on which the system is provided. The darker section 16 is arranged in such a way that an oncoming vehicle is not dazzled. Both the location of the section 15 and the location of the section 16 can be adjusted, by displacing the image contents on the image generators, to position changes of the motor vehicle driving in front or of the oncoming motor vehicle relative to the driver's own vehicle. In the process, the sections 15, 16 on the projection area 7, therefore on the road, can be displaced in different directions and in the vertical direction include, in each case, one of the other motor vehicles.

The more brightly illuminated section 17 can be arranged so that an approaching road sign or pedestrians or animals at the edge of the road can be illuminated more brightly, so that they can be better identified. The location of the section 17 can also be adjusted relative to the driver's own vehicle as said vehicle approaches, for example, the traffic sign, the pedestrian or the animal at the edge of the road. Less brightly illuminated sections prevent an unnecessary dazzling, for example, of oncoming traffic or of the driver of the motor vehicle, for instance when a large and highly reflective sign is lit up.

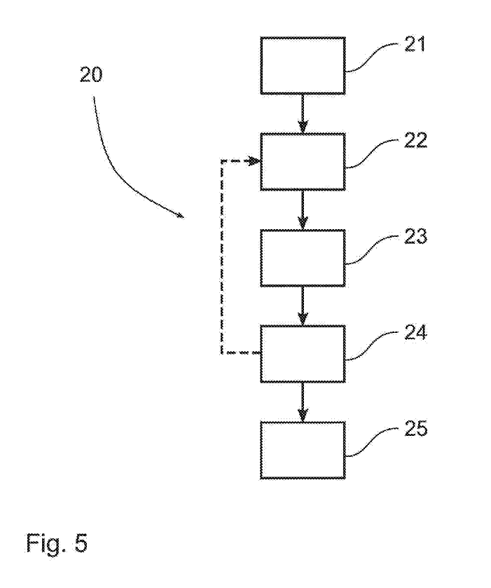

FIG. 5 diagrammatically shows an embodiment example of the method according to the invention for projecting image contents as a flowchart. The same reference numerals are used for elements of the embodiment examples of the previous figures, which are used to describe the method according to the invention below.

The method 20 starts with a first method step 21, in which, for example, the image contents are projected with a projection device 3. During the then following method step 22, the actual position of the image contents is determined with reference to an object and/or living thing located in the projection area 7. During the then following method step 23, the actual position is compared with a nominal position. The nominal position can, in this case, be the position of the living thing and/or object in the projection area 7 or adjacent to or above it. If the actual position deviates from the nominal position, the position of the image contents on the image generator is adjusted during the following method step 24 and, to this end, the image contents on the image generator are displaced for example. The nominal position can therefore be specified by an actual position of an object and/or living thing which can be acquired with the camera 5.

For example, the image contents or the partial image can be displaced pixel by pixel, until the actual position corresponds to the nominal position in the projection area 7. Method step 22 can follow method step 24, if the nominal position changes and the actual position is to be tracked. Alternatively, the method can end at method step 25 which follows method step 24.

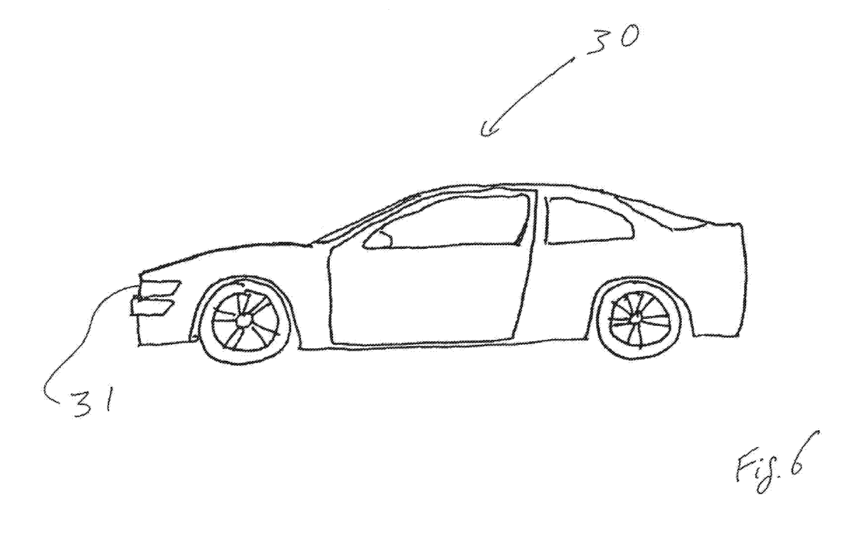

FIG. 6 shows a motor vehicle 30 according to the invention, by way of example as a car, having a headlight system 31 comprising the projector 1.

### LIST OF REFERENCE NUMERALS

1 Projector
2 Projection surface
3, 4 Projection device
5 Camera
6 Control device
7 Projection area
8 Image signal line
9, 10 Control signal line
11 Overlap area
12, 13 Projection cone/illumination cone
14 Inlet port cone
15, 16 Darker section
17 Lighter section
20 Method
21 Start/project partial images
22 Determine actual position
23 Compare actual position with nominal position
24 Adjust actual position
25 End
30 Vehicle
31 Headlight system

What is claimed is:

1. A headlight system (31) for a vehicle, having a projector (1) for selectively illuminating a projection area in different ways, wherein the projector (1) comprises at least one projection device (3, 4) having an image generator, wherein the image generator presents image contents for selective illumination in different ways during operation, and the projector (1) is configured to project the image contents onto the projection area (7), characterized in that
the projection device (3, 4) is configured to displace the image contents on the image generator in order to compensate for a relative movement between at least one selectively differently illuminated object and/or a selectively differently illuminated living thing in the projection area (7) and the headlight system (31).

2. The headlight system (31) according to claim 1, characterized in that the headlight system (31) comprises a camera (5) which is configured to record the projection area (7).

3. The headlight system (31) according to claim 2, characterized in that the headlight system (31) comprises a control device (6) which is connected to the camera (5) for receiving the image signal and is connected to the at least one image generator for transferring the control signal.

4. The headlight system (31) according to claim 3, characterized in that the control device (6) is configured to determine an actual position of the image contents in the projection area (7) on the basis of the image signal of the camera (5) and to displace the position of the image contents on the image generator in such a way that the image contents in the projection area (7) can be projected to a nominal position corresponding to the position of the object and/or of the living thing.

5. The headlight system (31) according to claim 1, characterized in that the headlight system (31) comprises two projection devices (3, 4) which each have an image generator, wherein each of the image generators produces image contents to be selectively illuminated in different ways during operation, and the headlight system (31) is configured to project the image contents of one of the image generators into a first section of the projection area (7) and the image contents of the other image generator into a second section of the projection area (7), wherein the projected image contents of both image generators are arranged with respect to one another without any gaps and/or overlapping one another.

6. The headlight system (31) according to claim 1, characterized in that the at least one projection device (3, 4) is a headlight of the headlight system (31).

7. A method (20) for illuminating a projection area (7) having a vehicle (30), in which an object and/or a living thing in or adjacent to the projection area (7) of the vehicle (30) is illuminated differently to the surroundings thereof, characterized in that a relative movement of the vehicle with respect to the object and/or the living thing is compensated for by displacement (24) of the image contents producing different illumination on an image generator of a headlight system (31) of the vehicle (30), in order to continue illuminating the object and/or the living thing differently.

8. The method according to claim 7, characterized in that the nominal position of one of the image contents is determined on the basis of the actual position of the object and/or of the living thing (23).

9. The method (20) according to claim 7, characterized in that sections available in the projection area (7) and selected as image contents are illuminated differently to other sections in the projection area (7).

10. A vehicle (30) having a headlight system (31), characterized in that the headlight system (31) is the headlight system (31) of claim 1.
